(19) United States
(12) Patent Application Publication
(10) Pub. No.: US 2009/0154401 A1
(43) Pub. Date: Jun. 18, 2009

(54) METHODS AND SYSTEMS FOR INITIAL RANGING

(75) Inventors: Rishi R. Arora, Chicago, IL (US); David R. Maas, Palatine, IL (US); John M. Harris, Glenview, IL (US); Jun Wang, Evanston, IL (US); Robert V. Stephens, Bartlett, IL (US); Samir S. Vaidya, Highland Park, NJ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/958,530

(22) Filed: Dec. 18, 2007

(51) Int. Cl. H04Q 7/00

(52) U.S. Cl. 370/329

(57) ABSTRACT

A method is provided for allocating initial ranging opportunities in a series of frames. According to the method, a number of initial ranging opportunities are allocated in frame N that occurs after a triggering event, and k frames after frame N the number of initial ranging opportunities is selectively reduced. The triggering event is one of system startup and broadcast of an Uplink Channel Descriptor message. Also provided is a base station that includes a controller for allocating a number of initial ranging opportunities in frame N that occurs after a triggering event. The controller selectively reduces the number of initial ranging opportunities k frames after frame N. The triggering event is one of system startup, broadcast of an Uplink Channel Descriptor message, broadcast of a page message, or broadcast of a signature for an overhead configuration message.

### BACKGROUND OF THE INVENTION

1. Field of the Invention

The present invention relates in general to wireless communication, and more particularly to methods and systems for performing initial ranging so that mobile subscriber stations can acquire access to a base station.

2. Description of the Related Art

The orthogonal frequency division multiple access (“OFDMA”) initial ranging procedure of the IEEE 802.16e/d specification requires a base station to periodically allocate a region in the uplink frame to allow subscriber stations to perform initial ranging. The initial ranging process is used by a subscriber station to initially access a cell, and the process allows the base station to determine timing, frequency, and power adjustments required for subsequent subscriber station transmissions. While these regions are required, in conventional systems they consume precious bandwidth regardless of whether or not they are actually used by a subscriber station.

Additionally, the initial ranging process is a contention-based method, so all active subscriber stations can attempt to use the same ranging region allocated in the up-link sub-frame to conduct the initial ranging process. This results in frequent collisions when two or more subscriber stations send an initial ranging request at the same time, using the same CDMA ranging code on the same sub-channel. Such collisions slow down the initial ranging process due to backoff algorithms and negatively impact the performance of the base station, which frequently creates a noticeable delay for subscriber station users.

The probability of collisions is the highest right after a system startup (for example, after a system restart or reset). At this time, all of the subscriber stations in the cell attempt initial ranging simultaneously, so there are many collisions. Further, conventional systems provide the same number of initial ranging opportunities in all frames. For example, one conventional system has a total of 210 usable uplink (“UL”) slots in each frame, and always allocates twelve of these slots for initial ranging. Because only twelve UL slots are allocated for initial ranging in all frames and all of the subscriber stations attempt initial ranging after system startup, only a very limited number of subscriber stations can successfully perform initial ranging without colliding in the first frame. Further, because immediately after system startup there are not yet any subscriber stations that have successfully performed initial ranging, all of the UL slots in the first frame that are not allocated for initial ranging go unused. Thus, in conventional systems, only a very limited number of subscriber stations can successfully perform initial ranging in the first frame after system startup, while at the same time the vast majority of the UL slots in this first frame go unused.

Therefore a need exists to overcome the problems with the prior art as discussed above.

### SUMMARY OF THE INVENTION

One embodiment of the present invention provides a method for allocating initial ranging opportunities in a series of frames. According to the method, a number of initial ranging opportunities are allocated in frame N that occurs after a triggering event, and k frames after frame N the number of initial ranging opportunities is selectively reduced. The triggering event is one of system startup, broadcast of an Uplink Channel Descriptor message, broadcast of a page message, or broadcast of a signature for an overhead configuration message.

Another embodiment of the present invention provides a base station that includes a controller for allocating a number of initial ranging opportunities in frame N that occurs after a triggering event. The controller selectively reduces the number of initial ranging opportunities k frames after frame N. The triggering event is one of system startup, broadcast of an Uplink Channel Descriptor message, broadcast of a page message, or broadcast of a signature for an overhead configuration message.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a wireless communication network in accordance with one embodiment of the present invention;

FIG. 2 is an illustration of a cellular mapping pattern for a group of cells in accordance with one embodiment of the present invention;

FIG. 3 is a flow diagram for an initial ranging slot allocation process following system startup in accordance with one embodiment of the present invention;

FIG. 4 is an illustration of initial ranging slot allocation after system startup in accordance with one embodiment of the present invention;

FIG. 5 is a flow diagram for an initial ranging slot allocation process following UCD broadcast in accordance with one embodiment of the present invention;

FIG. 6 is an illustration comparing initial ranging slot allocation in one embodiment of the present invention with initial ranging slot allocation in a conventional system; and

FIG. 7 is a block diagram illustrating a base station controller according to one exemplary embodiment of the present invention.

### DETAILED DESCRIPTION

As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of embodiments of the present invention. While the specification concludes with claims defining the features of the present invention that are regarded as novel, it is believed that the present invention will be better understood from a consideration of the following description in conjunction with the drawing figures, in which like reference numerals are carried forward.

Embodiments of the present invention allocate initial ranging slots based on the probable number of subscriber stations that will attempt initial ranging in a given frame after a “triggering event.” Triggering events include system startup, broadcast of the Uplink Channel Descriptor (UCD) by a base station, broadcast of a page message, and/or broadcast of a signature for an overhead configuration message.

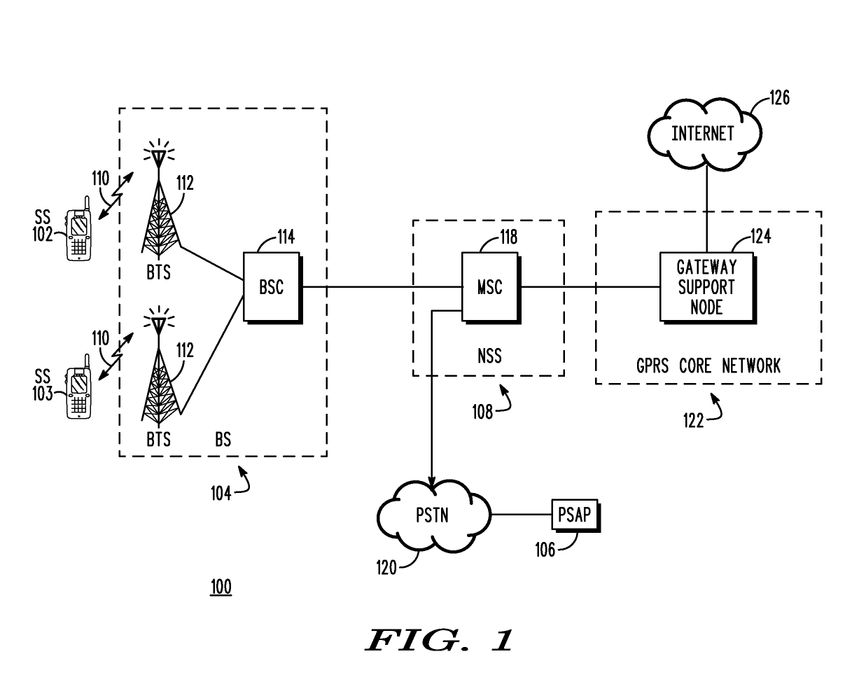

FIG. 1 is a diagram of a wireless communication network 100 in accordance with one embodiment of the present invention. As shown, a mobile subscriber station 102 communicates with a base station subsystem 104 to link to other subscriber stations 103. The base station 104 is the section of the network that is responsible for handling traffic and communication between the subscriber station 102 and a network switching subsystem 108. The base station 104 allocates radio channels to mobile phones (i.e., subscriber stations), transcodes speech channels, and performs paging, quality management of transmission and reception over the wireless link 110, and many other tasks related to the radio network.

A base transceiver station 112 establishes service areas in the vicinity of the base station 104 to support wireless mobile communication. Each base transceiver station 112 contains transceiver equipment, including a transmitter and a receiver coupled to an antenna, for transmitting and receiving radio signals.

The base transceiver stations 112 are controlled by a base station controller 114. The base station controller 114 handles allocation of radio channels, receives measurements from the subscriber stations 102, and controls handovers from base transceiver station to base transceiver station. The base station controller 114 will typically control tens or even hundreds of base transceiver stations 112. The base station controller 114 also stores databases for the sites, including information such as carrier frequencies, frequency hopping lists, power reduction levels, and receiving levels for cell border calculation. The base transceiver stations 112 include equipment for encrypting and decrypting communications with the base station controller 114. Typically, the base transceiver station 112 will have multiple transceivers to allow it to serve multiple frequencies and sectors of a cell.

While only one base station controller is shown for simplicity, the network can have multiple base station controllers distributed into regions near their respective base transceiver stations, with the base station controllers connected to a large centralized mobile switching center 118 of the network switching subsystem 108. The mobile switching center 118 is a sophisticated telephone exchange that provides circuit-switched calling, mobility management, and other services to the mobile phones operating within the area that it serves.

The network switching subsystem 108 is the component of the wireless network that carries out switching functions and manages the communications between mobile subscriber stations 102 and the Public Switched Telephone Network (“PSTN”) 120. The PSTN 120 is the collection of interconnected public circuit-switched telephone networks and is in many ways similar to the Internet, which is the collection of interconnected public IP-based packet-switched networks. The PSTN 120 is largely governed by technical standards and uses E.163/E.164 addresses (known more commonly as “telephone numbers”) for addressing.

The mobile switching center 118 is coupled to a General Packet Radio Services (“GPRS”) core network 122, which provides mobility management, session management, and transport for Internet Protocol (“IP”) packet services. The GPRS network 122 includes a GPRS gateway support node 124, which provides an interface between the GPRS wireless data network 122 and other networks, such as the Internet 126 or private networks.

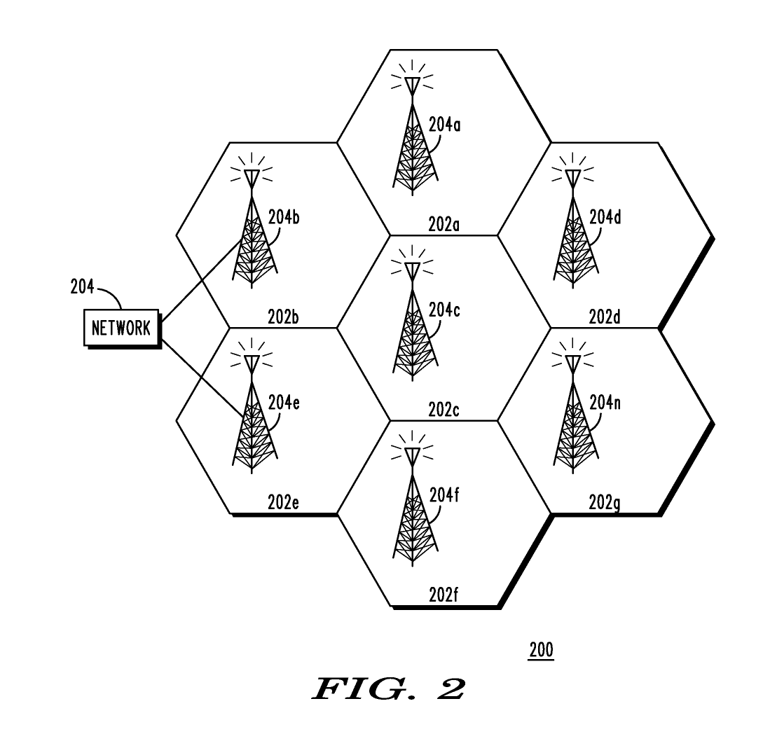

FIG. 2 illustrates a cellular mapping pattern 200 for a group of cells 202a-n in accordance with one embodiment of the present invention. The cells 202a-n represent coverage of a communication network 204 of a carrier. The communication network 204 includes a deployed set of base transceiver stations 204a-n, which each serve one of the cells 202a-n within the cellular pattern 200. Wireless devices (i.e., subscriber stations) that subscribe to the network 204 of the carrier are able to connect to any of the base transceiver stations 204a-n to receive the wireless services provided by that carrier.

In a conventional system, the number of initial ranging opportunities is limited by the number of initial ranging uplink (“UL”) slots in a frame, the number of sub-channels for ranging, and the availability of the code division multiple access (“CDMA”) ranging code, as well as collisions between initial ranging requests from different subscriber stations. Such collisions occur when two or more subscriber stations send an initial ranging request at the same time, using the same CDMA ranging code, on the same sub-channel. When this happens, energy is received at the base station 104, but the codes that are simultaneously transmitted interfere with each other so that no code is clearly received and understood by the base station 104.

When a base station system starts up (e.g., a first time boot up or after a system restart or reset), the only activity of the mobile subscriber stations will be initial ranging. And after the system reset, all subscriber stations in a cell will attempt initial ranging simultaneously. Due to the limited number of UL slots allocated to initial ranging in conventional systems, in a heavily loaded cell many subscriber stations will experience collision and thus delayed network entry.

In one embodiment of the present invention, substantially all of the uplink bandwidth after system startup is used for initial ranging. (In the context of the present invention, the phrase “substantially all” includes all or nearly all of the available uplink bandwidth.) The allocation of substantially all of the uplink bandwidth to initial ranging means that the number of UL slots in the first frame after system startup is greatly increased, so that a greater number of subscriber stations can perform initial ranging. The uplink bandwidth (i.e., number of UL slots) allocated to initial ranging is selectively reduced in subsequent frames, based on the number of subscriber stations that have successfully performed initial ranging and the number of subscriber stations that have failed initial ranging.

Because there is no uplink traffic besides initial ranging immediately after system startup, this allocation of substantially all UL slots for initial ranging does not adversely affect system performance. To the contrary, it improves system performance by increasing the success rate of initial ranging by subscriber stations, and thus expedites network entry for the subscriber stations.

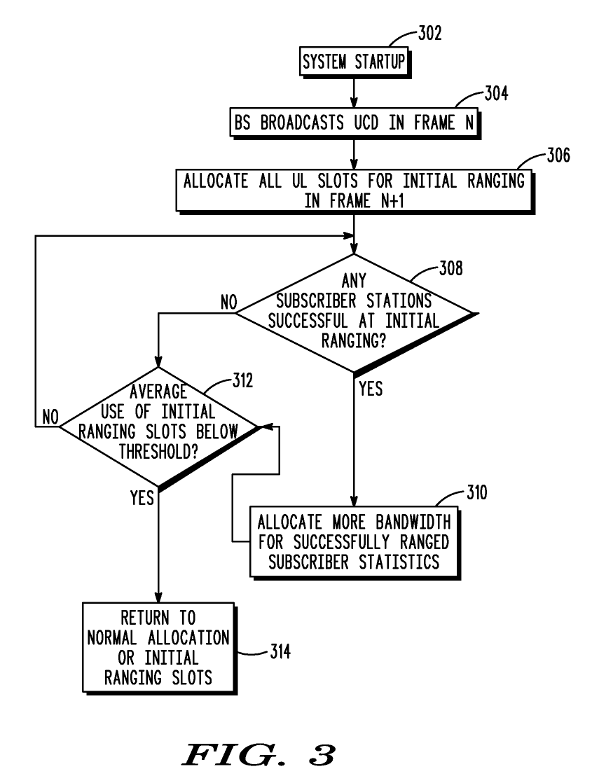

FIG. 3 shows the initial ranging slot allocation process according to this embodiment of the present invention. At step 302, there is a system startup, such as a first time boot up, a system restart, or a system reset. In step 304, the base station 104 broadcasts the first UCD message in frame N. In step 306, all of the uplink bandwidth is allocated for initial ranging by allocating substantially all UL slots for initial ranging starting with frame N+1. The base station then monitors the number of successful and failed initial ranging attempts. The number of successful and failed initial ranging attempts can be obtained by querying physical layer statistics. Further, in the case of a system reset, the total number of users in the cell before the reset can be obtained by reading the check pointing logs saved in non-volatile memory. This information can then be used in estimating the number of subscriber stations that still need to perform initial ranging.

In step 308, the base station determines if any subscriber stations have been successful at initial ranging in the preceding k frames (for example, but not limited to, the one preceding frame). If not, the process proceeds to step 312. If so, in step 310 the base station allocates less UL slots in the next frame for initial ranging. The allocation of the initial ranging slots is reduced in the subsequent frame based on the number of subscriber stations that were successful at initial ranging and the number of failed initial ranging attempts. Uplink bandwidth is allocated to subscriber stations that have successfully performed initial ranging so they can start sending uplink data traffic. Unused uplink bandwidth is still allocated for initial ranging to allow other subscriber stations to attempt initial ranging or attempt initial ranging again. Preferably, sufficient bandwidth is allocated for use by the subscriber stations that have initially ranged, while substantially all of the unused bandwidth is still allocated for initial ranging. The process then proceeds to step 312.

This is repeated as shown in FIG. 3 until, in step 312, it is determined that the average usage of the initial ranging slots over m frames is below a threshold. The value of m depends on several other configuration parameters in the system. For example, in one embodiment, m is equal to “2̂Initial Ranging Backoff Start”, with Initial Ranging Backoff Start being the configuration parameter that indicates an initial range of frames over which a subscriber can choose to do initial ranging. If there are collisions, the subscriber keeps increasing this range until it reaches “2̂Initial Ranging Backoff End”.

If the average usage is below the threshold, this indicates that few subscriber stations are attempting initial ranging, so the number of initial ranging slots per frame is returned to the normal allocation, in step 314. In an alternative embodiment, in step 308 the base station determined if less than a threshold number of subscriber stations attempted initial ranging in the preceding k frames.

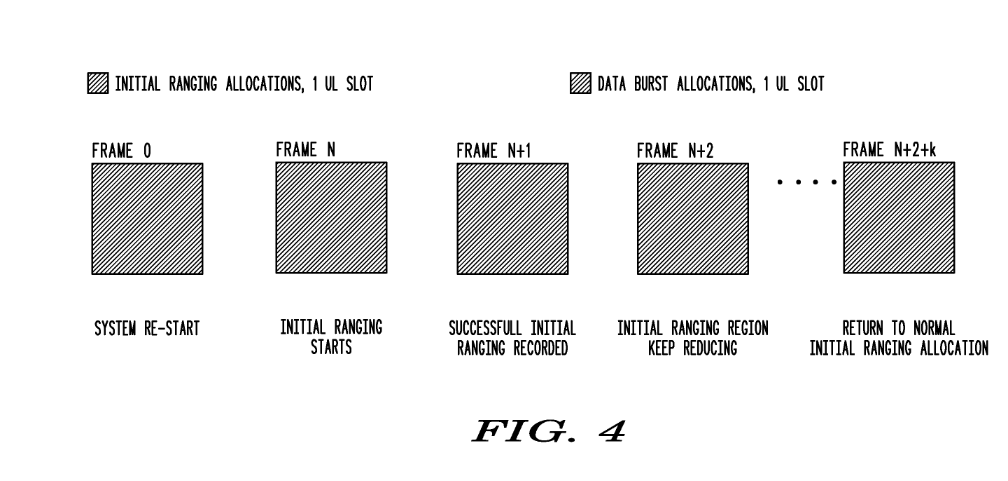

FIG. 4 shows an example of initial ranging slot allocation in a series of frames after system startup in accordance with one embodiment of the present invention. The first frame, Frame 0, occurs after system startup. Frame 0 is comprised completely of initial ranging slots. This is continued through when initial ranging starts in Frame N, which is also comprised completely of initial ranging slots. In the next frame, Frame N+1, successful initial ranging has been recorded so the number of initial ranging slots per frame is reduced. In particular, in Frame N+1 there are allocated two data burst slots. In subsequent frames, successful initial ranging continues to be recorded with a corresponding increase in the number of UL slots that are allocated as data burst slots. Eventually, in Frame N+2+k, a sufficient number of the subscriber stations have successfully performed initial ranging so that the use of the initial ranging slots falls below a threshold. Therefore, at this point the allocation of initial ranging slots is returned to the normal allocation.

Accordingly, there is provided an initial ranging slot allocation process that increases the initial ranging opportunities following system startup. Because there is no uplink traffic besides initial ranging immediately after system startup, the allocation of substantially all UL slots for initial ranging after system startup does not decrease system performance. To the contrary, the usage of UL bandwidth is increased, so that the number of subscriber stations that are successful at initial ranging can be increased to expedite the network entry process.

Another embodiment of the present invention uses broadcast of the UCD message as the triggering event for estimating the probability of subscriber stations performing initial ranging. More specifically, Downlink and Uplink Channel Descriptors (DCD and UCD) are periodically broadcast by the base station. A subscriber station needs to receive these Downlink and Uplink Channel Descriptors (DCD and UCD) before attempting to perform initial ranging. Therefore, the probability of subscriber stations attempting to perform initial ranging is the highest just after DCD and UCD are broadcasted. This probability decreases over time so that initial ranging becomes least likely just before the DCD and UCD are broadcasted again. This probability curve over time can be used to determine the optimal size of the ranging region so that excess initial ranging bandwidth can be removed.

Additionally, in some systems the signature or sequence number or Configuration Change Count of the overhead configuration message (of which the DCD and UCD are examples) is broadcast more frequently than the DCD or UCD messages themselves. In some such systems the subscriber station must wait for an overhead message to broadcast the current signature number in order to confirm that the current signature of the current overhead configuration message is the same as the last overhead configuration message that the subscriber station received. In this way, the subscriber station verifies that its understanding of the system configuration is still up-to-date before performing access. If the signature number of the overhead message already stored by the subscriber station is the same as the signature number broadcast by the system, then the subscriber station does not need to wait for the actual UCD DCD message itself. As a result, in such a system, there may also be an increase in access load immediately after the signature or sequence number of the overhead configuration message is broadcast. The probability of higher load then decreases over time. The probability curve over time can be used to determine the optimal size of the ranging region so that excess initial ranging bandwidth can be removed.

Additionally, in many systems subscriber stations are informed of an incoming call through the use of a page message. As a result, there may also be an increase in access load immediately after a page message is broadcast. This probability of higher load also decreases over time. Again, the probability curve over time can be used to determine the optimal size of the ranging region so that excess initial ranging bandwidth can be removed.

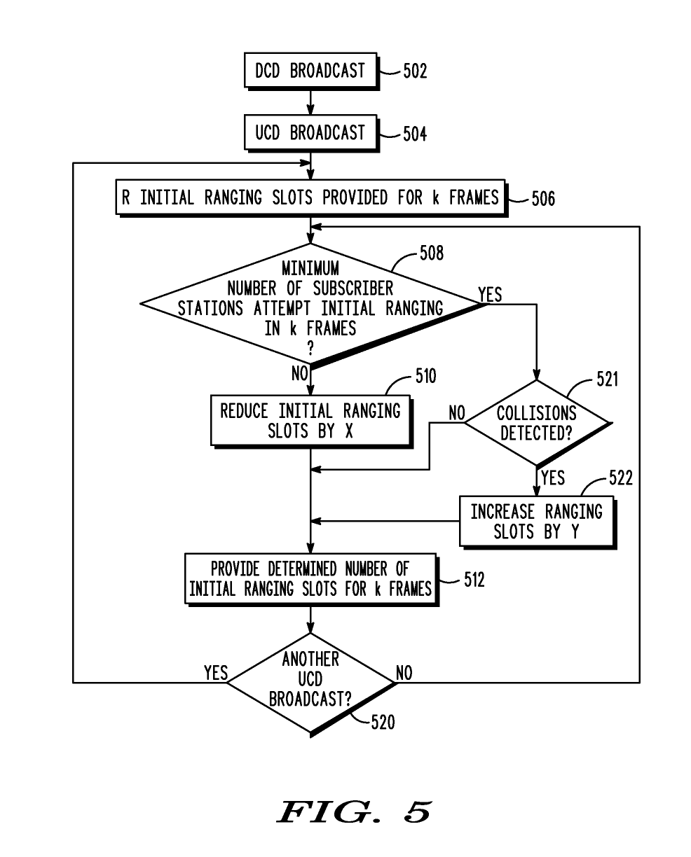

FIG. 5 shows an initial ranging slot allocation process according to an embodiment of the present invention where the triggering event is at least one of the UCD or DCD message. However, as described above, the triggering event could also, or instead, be the broadcast of a page message, or the broadcast of a signature for an overhead configuration message. In step 502, the DCD message is broadcast in frame N−1. In step 504, the UCD message is broadcast in frame N. In step 506, a number R of initial ranging slots is provided in frames N+1. This number R of initial ranging slots is repeated for k frames (i.e., through frame N+k). The values of R and K are dependent on the operator's frame configuration, channel bandwidth, and the like. The values used for a frame with a 50/50 duty cycle would typically be very different from those used for a frame with a 75/25 duty cycle. As an example, in this embodiment, assuming a 75/25 duty cycle and 10 MHz bandwidth, R is equal to 8 initial ranging opportunities and k is equal to 2 times 2̂Initial Ranging Backoff Start. In this description, “initial ranging opportunity” is interchangeable with “initial ranging slot” (e.g., meaning 2 symbols×6 subchannels).

The number of subscriber stations that attempt initial ranging is monitored. In step 508, it is determined whether or not at least a threshold number of subscriber stations (e.g., one) attempted initial ranging in these k frames. If not, then in step 510 the number of initial ranging slots is reduced by a factor of x (e.g., by half), and the process proceeds to step 512. In this embodiment, x is equal to 2, independent of the frame configuration. Thus, the starting point in this embodiment is 8 in initial ranging opportunities, then after k frames this drops to 4 opportunities, and then to 2 opportunities after the next k frames. Preferably, the number of initial ranging slots is not reduced to less than one per frame.

On the other hand, if less than the threshold number of subscriber stations attempted initial ranging, then in step 521 it is determined whether or not more than a specified number of ranging collisions were detected for the k frames. If not, the process proceeds to step 512. Conversely, if more than a specified number of ranging collisions were detected, then in step 522 the number of initial ranging slots is increased by a factor of y (e.g., doubled), and the process proceeds to step 512. In this embodiment, y is equal to 2. Thus, the number of initial ranging opportunities is doubled if collisions are detected.

In step 512, the determined number of initial ranging slots is provided per frame for the following k frames. Then, in step 520, it is determined whether another UCD message has been broadcasted. If not, the process returns to step 508 to determine the number of subscriber stations that attempt initial ranging in k frames. If so, then the process returns to step 506 in which R initial ranging slots are provided for the following k frames. If k is not an integer multiple of the number of frames between UCD broadcasts, then step 520 can occur before an entire series of k frames occur in step 512.

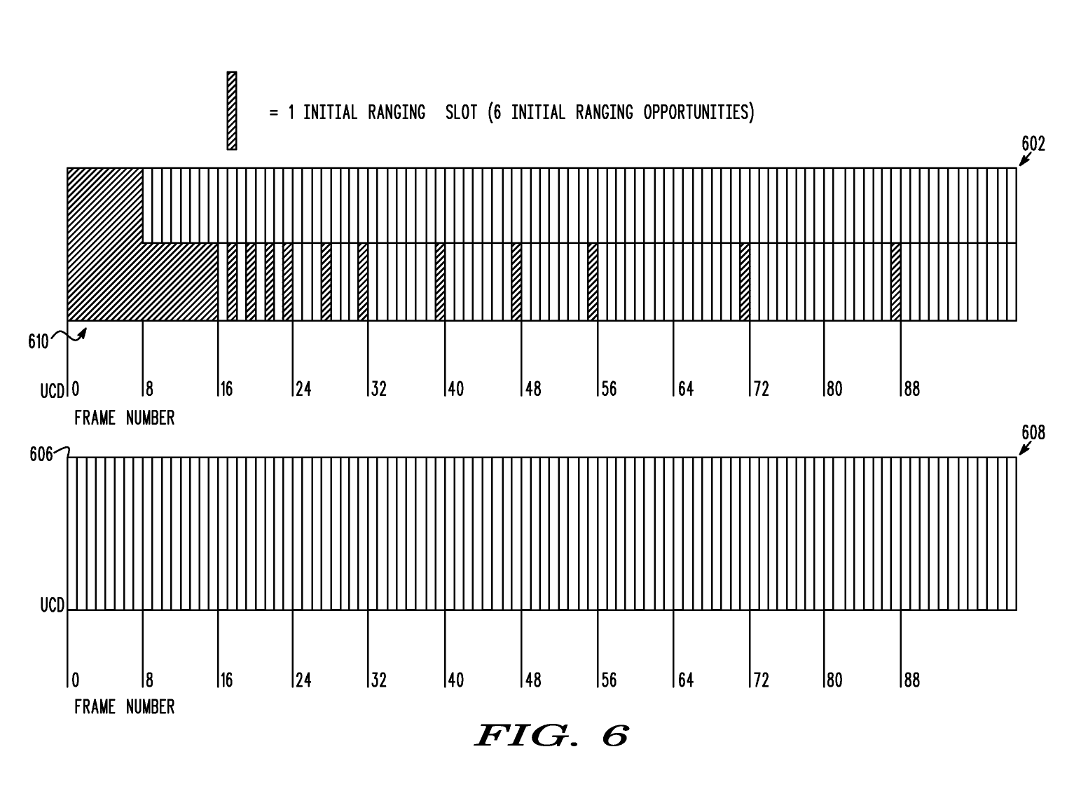

FIG. 6 compares an example of initial ranging slot allocation in a series of frames after UCD broadcast in accordance with one embodiment of the present invention with initial ranging slot allocation in a conventional system. In the conventional allocation 608, a set number of initial ranging slots 606 are allocated in every frame. In contrast, in the allocation according to this embodiment of the present invention 602, UL slots are allocated for initial ranging based on the probability that subscriber stations will attempt initial ranging. The broadcast of the UCD message is used as the triggering event in this probability determination. In particular, all UL slots are allocated as initial ranging slots 610 for the first k frames after broadcast of the UCD message (i.e., frames 0 through 7).

Based on the usage of the initial ranging slots during these k frames, the number of initial ranging slots per frame is increased or held steady. In this embodiment, if less than 20% of the initial ranging slots are used over the k frames, the number of initial ranging slots is reduced by half. As shown, this occurs in the illustrated example after frame 7, frame 15, frame 23, frame 31, and frame 55. The number of initial ranging slots is not decreased if it falls to a minimum (e.g., one initial ranging slot every 2k frames). If at least 20% of the initial ranging slots are used over the k frames, the number of initial ranging slots is held steady. As shown, this occurs in the illustrated example after frame 39 and frame 47. The number of initial ranging slots is not decreased if it falls to a minimum (e.g., one initial ranging slot every 2k frames).

This is repeated every k frames until the UCD message is broadcast again. Optionally, the number of initial ranging slots per frame can be increased based on the number of ranging collisions that occur during the preceding k frames.

Accordingly, there is provided an initial ranging clot allocation process in which the opportunity for subscriber stations to perform initial ranging is increased when it is more likely that subscriber stations will perform initial ranging. This reduces the possibility of collision and thus expedites the network entry process. Further, when it is less likely that subscriber stations will perform initial ranging, less bandwidth is dedicated for performing initial ranging.

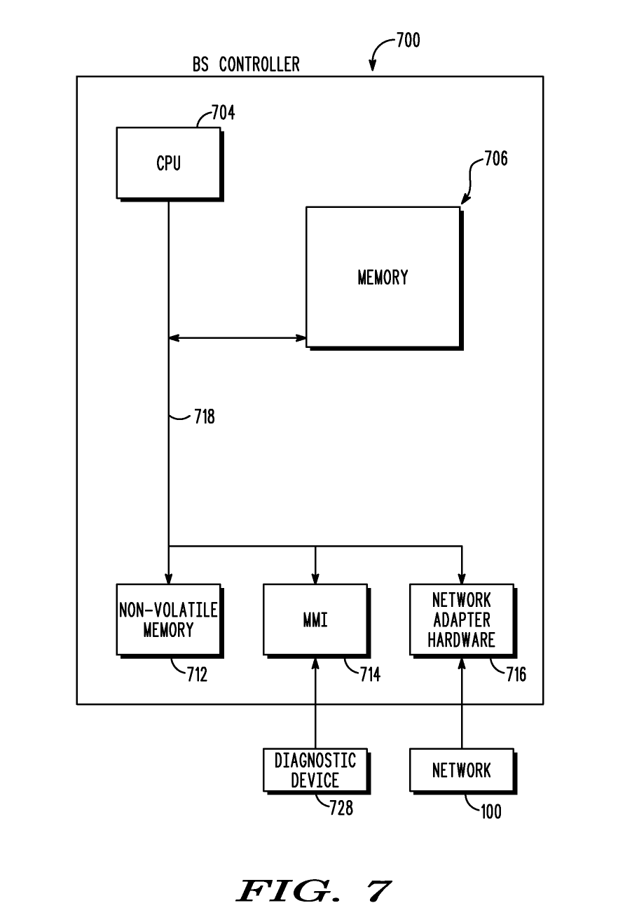

FIG. 7 is a block diagram illustrating a base station controller according to one exemplary embodiment of the present invention. The base station controller 700 of this embodiment resides within a base transceiver station 112. In other embodiments, the base station controller 700 can reside outside of the base transceiver station 112. The base station controller 700 of FIG. 7 includes a processor/controller 704 that is communicatively connected to a main memory 706 (e.g., volatile memory), a non-volatile memory 712, and network adapter hardware 716 that is used to provide an interface (i.e., input/output) to a network 100. The processor/controller 704 in conjunction with the network adapter hardware 716, the base transceiver station 112, and instructions in memory 706 works to strategically allocate UL bandwidth for initial ranging.

An embodiment of the present invention can be adapted to work with any data communications connections including present day analog and/or digital techniques or via a future networking mechanism. The base station controller 700 also includes a man-machine interface (“MMI”) 714. The MMI 714 of this embodiment is used to directly connect one or more diagnostic devices 728 to the base station controller 700. A system bus 718 interconnects these system components.

As described above, embodiments of the present invention increase the number of initial ranging slots after a triggering event so as to expedite the network entry process. This not only improves base station performance, but also improves the subscriber experience.

The present invention may be realized in hardware, software, or a combination of hardware and software. A system according to an exemplary embodiment of the present invention may be realized in a centralized fashion in one computer system, or in a distributed fashion where different elements are spread across several interconnected computer systems. Any kind of computer system—or other apparatus adapted for carrying out the methods described herein—is suited. A typical combination of hardware and software might be a general purpose computer system with a computer program that, when being loaded and executed, controls the computer system in order to carry out the methods described herein.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the present invention have been illustrated and described, it will be clear that the present invention is not so limited. Numerous modifications, changes, variations, substitutions and equivalents will occur to those skilled in the art without departing from the spirit and scope of the present invention as defined by the appended claims.

What is claimed is:

1. A method for allocating initial ranging opportunities in a series of frames, the method comprising:
allocating a number of initial ranging opportunities in frame N that occurs after a triggering event; and
k frames after frame N, selectively reducing the number of initial ranging opportunities, wherein the triggering event is one of system startup, broadcast of an Uplink Channel Descriptor message, broadcast of a page message, and broadcast of a signature for an overhead configuration message.

2. The method according to claim 1,
wherein the triggering event is system startup; and
the number of initial ranging opportunities in frame N comprises all of the uplink bandwidth.

3. The method according to claim 2,
wherein k is 1; and
the selectively reducing step comprises reducing the number of initial ranging opportunities in frame N+(x*k) if at least one subscriber station was successful at initial ranging in the k frames immediately preceding frame N+(x*k), and repeating this step after k more frames.

4. The method according to claim 3, wherein the selectively reducing step further comprises reducing the initial ranging opportunities to a determined number in frame N+(x*k) if use of initial ranging opportunities over m frames immediately preceding frame N+(x*k) is below a threshold.

5. The method according to claim 1, wherein
the triggering event is broadcast of the Uplink Channel Descriptor message; and
the selectively reducing step comprises reducing the number of initial ranging opportunities by x in frame N+(x*k) if less than a threshold number of subscriber stations attempted initial ranging in the k frames immediately preceding frame N+(x*k), and repeating this step after k more frames.

6. The method according to claim 5, wherein k is greater than 1.

7. The method according to claim 5, further comprising increasing the number of initial ranging opportunities by y in frame N+(x*k) if collisions are detected between subscriber stations attempting initial ranging in the k frames immediately preceding frame N+(x*k).

8. The method according to claim 1, wherein
the triggering event is broadcast of the Uplink Channel Descriptor message; and
the selectively reducing step comprises reducing the number of initial ranging opportunities by x in frame N+(x*k) if less than a threshold of the initial ranging opportunities are used in the k frames immediately preceding frame N+(x*k), and repeating this step after k more frames.

9. A base station comprising:
a controller for allocating a number of initial ranging opportunities in frame N that occurs after a triggering event,
wherein k frames after frame N, the controller selectively reduces the number of initial ranging opportunities, and
wherein the triggering event is one of system startup, broadcast of an Uplink Channel Descriptor message, broadcast of a page message, and broadcast of a signature for an overhead configuration message.

10. The base station according to claim 9, wherein
the triggering event is system startup; and
all of the uplink bandwidth is allocated by the controller for initial ranging opportunities in frame N.

11. The base station according to claim 10,
wherein k is 1; and
the controller reduces the number of initial ranging opportunities by reducing the number of initial ranging opportunities in frame N+(x*k) if at least one subscriber station was successful at initial ranging in the k frames immediately preceding frame N+(x*k), and repeating this step after k more frames.

12. The base station according to claim 11, wherein the controller reduces the number of initial ranging opportunities to a determined number in frame N+(x*k) if use of the initial ranging opportunities over m frames immediately preceding frame N+(x*k) is below a threshold.

13. The base station according to claim 9, wherein
the triggering event is broadcast of the Uplink Channel Descriptor message, and
the controller reduces the initial ranging opportunities by x in frame N+(x*k) if less than a threshold number of subscriber stations attempted initial ranging in the k frames immediately preceding frame N+(x*k), and repeating this step after k more frames.

14. The base station according to claim 13, wherein the controller increases the amount of uplink bandwidth allocated for initial ranging opportunities by y in frame N+(x*k) if collisions are detected between subscriber stations attempting initial ranging in the k frames immediately preceding frame N+(x*k).

15. The base station according to claim 9, wherein
the triggering event is broadcast of the Uplink Channel Descriptor message; and
the controller reduces the initial ranging opportunities by x in frame N+(x*k) if less than a threshold of the initial ranging opportunities are used in the k frames immediately preceding frame N+(x*k), and repeating this step after k more frames.

16. A computer program product for allocating initial ranging opportunities in a series of frames, the computer program product comprising:
a storage medium readable by a processing circuit and storing instructions for execution by the processing circuit for performing the steps of:
allocating a number of initial ranging opportunities in frame N that occurs after a triggering event; and
k frames after frame N, selectively reducing the number of initial ranging opportunities,
wherein the triggering event is one of system startup, broadcast of an Uplink Channel Descriptor message, broadcast of a page message, and broadcast of a signature for an overhead configuration message.

17. The computer program product according to claim 16, wherein
the triggering event is system startup; and
the number of initial ranging opportunities in frame N is all of the uplink slots.

18. The computer program product according to claim 17, wherein
k is 1; and
the selectively reducing step comprises reducing the number of initial ranging opportunities in frame N+(x*k) if at least one subscriber station was successful at initial ranging in the k frames immediately preceding frame N+(x*k), and repeating this step after k more frames.

19. The computer program product according to claim 16, wherein
the triggering event is broadcast of the Uplink Channel Descriptor message; and
the selectively reducing step comprises reducing the number of initial ranging opportunities by x in frame N+(x*k) if less than a threshold number of subscriber stations attempted initial ranging in the k frames immediately preceding frame N+(x*k), and repeating this step after k more frames.

20. The computer program product according to claim 16, wherein
the triggering event is broadcast of the Uplink Channel Descriptor message; and
the selectively reducing step comprises reducing the number of initial ranging opportunities by x in frame N+(x*k) if less than a threshold of the initial ranging opportunities are used in the k frames immediately preceding frame N+(x*k), and repeating this step after k more frames.
